(19) United States
(12) Patent Application Publication
(10) Pub. No.: US 2004/0128828 A1
(43) Pub. Date: Jul. 8, 2004

(54) Surface mounting device and the method thereof

(75) Inventors: Ji Hyun Hwang, Kyungki-do (KR); Do Hyun Kim, Kyungki-do (KR)

Correspondence Address: FLESHNER & KIM, LLP, P.O. BOX 221200, CHANTILLY, VA, 20153, US

(73) Assignee: Mirae Corporation

(21) Appl. No.: 10/740,425

(22) Filed: Dec. 22, 2003

Related U.S. Application Data
(63) Continuation of application No. 09/988,700, filed on Nov. 20, 2001, now abandoned.

(30) Foreign Application Priority Data
Nov. 24, 2000 (KR) 2000-70457

(51) Int. Cl. B23P 19/00

(52) U.S. Cl. 29/739; 29/742; 29/33 P

(57) ABSTRACT

A surface mounting device of the present invention has a printed circuit board carrier including a plurality of transfers installed at a predetermined portion of a base frame; and a plurality of conveyers movable in a predetermined direction. A surface mounting method of the present invention comprises the steps of: transferring a printed circuit board from a first transfer to one of a plurality of conveyers movable in a predetermined direction; perform the mounting of parts from a feeder on the printed circuit board; transferring the printed circuit board onto which parts have been mounted to the other one of the plurality of conveyers; and transferring the printed circuit board to a second transfer.

### BACKGROUND OF THE INVENTION

1. Field of the Invention

The present invention relates to a surface mounting device and the method thereof, and more particularly, to a surface mounting device and a method thereof capable of transferring a printed circuit board in various ways.

2. Description of the Related Art

A surface mounting device includes a base frame, an X-Y gantry, a head unit, a printed circuit board carrier and a feeder. The X-Y gantry is assembled over the base frame and moves in X-Y axis directions of the head unit. The head unit is assembled at the X-Y gantry and mounts parts fed through the feeder on a printed circuit board as it moves. The printed circuit board onto which the parts are mounted is carried to a parts mounting position by the printed circuit board.

The constitution of the surface mounting device for mounting the parts on the printed circuit board carried to the parts mounting position will now be described in more detail with reference to the accompanying drawings. FIG. 1 is a perspective view of a conventional surface mounting device. As illustrated therein, the surface mounting device 10 includes a base frame 11, an X-Y gantry 12, first and second head units 13 and 14, a printed circuit board carrier 15 and a feeder 16. The base frame 11 is used for supporting the full load of the surface mounting device 10 and the X-Y gantry 12 is installed on a plane of the base frame 11.

The X-Y gantry 12 includes a Y-axis stator frame 12a, a plurality of Y axis permanent magnets 12b, a Y-axis mover 12c, an X-axis stator frame 12d, a plurality of X-axis permanent magnets 12e, and a X-axis mover 12f. On an inner sidewall of the Y-axis stator frame 12a, the plurality of Y-axis permanent magnets 12b each formed of N and S poles are assembled, and, on an inner sidewall of the X-axis stator frame 12d, the plurality of X-axis permanent magnets 12e each formed of N and S poles are installed. The Y-axis mover 12c is installed inside the Y-axis stator frame 12a at which the Y-axis permanent magnets 12b are assembled, and the X-axis mover 12f is installed inside the X-axis stator frame 12d.

The first head unit 13 is installed on a plane of the X-axis mover 12f. When an electric signal is fed to a plurality of armature coils (not shown) assembled at the X-axis mover 12f, the first head unit 13 moves in a X-axis direction by a thrust force generated between the armature coils and the X-axis permanent magnets 12e. To move the first head unit 13 in a Y-axis direction, the X-axis stator frame 12d is moved in the Y-axis direction.

To move the X-axis stator frame 12d in the Y-axis direction, the X-axis stator frame 12d is formed integrally with the Y-axis mover 12c. The Y-axis mover 12c having the X-axis stator frame 12d formed integrally is assembled inside the Y-axis stator frame 12a. When an electric signal is fed to the plurality of armature coils (not shown) assembled at the Y-axis mover 12c, a thrust force is generated between the armature coils and the Y-axis permanent magnets 12b. By this thrust force, the Y-axis mover 12c is moved in the Y-axis direction.

As the Y-axis mover 12c moves, the X-axis stator frame 12d formed integrally with the Y-axis mover 12c moves in the Y-axis direction and thusly the first head unit 13 moves in the Y-axis direction. The second head unit 14 moves in the X-Y axis directions in the same way as the first head unit 13. The first head unit 13 and the second head unit 14 moving in the X-Y axis directions mount parts on the printed circuit board carried by the printed circuit board carrier 15.

To mount parts on the printed circuit board using the first head unit 13 and the second head unit 14, firstly, the first head unit 13 and the second head unit 14 suck parts. The parts are mounted at the feeder 16 in a tape reel (not shown) state. When the parts are separated from the tape reel mounted at the feeder 16, the first head unit 13 and the second head unit 14 suck the parts and then the parts are mounted on the printed circuit board 1. The printed circuit board 1 onto which the parts are mounted will now be described with reference to the accompanying drawings.

As illustrated in FIG. 2, the printed circuit board carrier 15 includes a base frame 15a, first and second guide frames 15b and 15c, a width adjusting screw 15d, a plurality of lifting members 15e, a stopper 15f, a stopper roller 15g, and a width adjusting screw 15h. The first guide frame 15b and the second guide frame 15c are installed at both side of the base frame 15a. The width adjusting screw 15d is installed between the first guide frame 15b and the second guide frame 15c. The width adjusting screw 15h is installed at a predetermined distance from the width adjusting screw 15d.

The stopper 15f assembled at the stopper roller 15g is positioned at one side of the width adjusting screw 15h, and the plurality of lifting members 15e are provided between the width adjusting screw 15d and the width adjusting screw 15h. The width adjusting screw 15d carries the printed circuit board 1 to a parts mounting work position (a). When the printed circuit board 1 carried by the width adjusting screw 15d is carried to the parts mounting work position (a) by the stopper 15f, the position is fixed by the lifting members 15e. Afterwards, when the mounting of parts is finished, the printed circuit board 1 is discharged by the width adjusting screw 15h of the printed circuit board 1.

As described above, since the conventional surface mounting device with a printed circuit board carrier is constructed in a single structure, it can mount parts carried by a plurality of head units on only one printed circuit board, and thusly the productivity of the mounting cannot be improved.

### SUMMARY OF THE INVENTION

It is, therefore, an object of the present invention to provide a surface mounting device and the method thereof which simultaneously can mount parts to two or more printed circuit boards.

It is another object of the present invention to provide a surface mounting device and the method thereof which simultaneously can mount parts to two or more printed circuit boards, thereby improving the productivity of the parts mounting work.

To achieve the above object, there is provided, in a surface mounting device including an X-Y gantry mounted on a base frame, a plurality of head units mounted on predetermined positions of the X-Y gantry, a parts feeder for supplying parts mounted on a printed circuit board carried to a parts mounting work position, the surface mounting device comprising: a plurality of transfers movably mounted on both sides of the base frame in parallel with each other; a plurality of movable conveyers in X and Y directions mounted between the plurality of transfers; and a plane power transmission device for generating a driving force for moving the plurality of conveyers into X and Y directions.

In addition, there is provided a surface mounting method comprising the steps of: transferring a printed circuit board from a first transfer to one of a plurality of conveyers movable in a predetermined direction; performing the mounting work of parts from a feeder on the printed circuit board; transferring the printed circuit board onto which parts have been mounted to the other one of the plurality of conveyers; and transferring the printed circuit board to a second transfer.

### BRIEF DESCRIPTION OF THE DRAWINGS

The above objects, features and advantages of the present invention will become more apparent from the following detailed description when taken in conjunction with the accompanying drawings, in which:

FIG. 1 is a perspective view of a conventional surface mounting device;

FIG. 2 is a perspective view of a conveyer as illustrated in FIG. 1;

FIG. 3 is a plane view of a surface mounting device to which a printed circuit board carrier is adapted according to the present invention;

FIG. 4 is a perspective view of the printed circuit board as illustrated in FIG. 3; and

FIGS. 5a through 5c are plane views of the surface mounting device for explaining a surface mounting method using the printed circuit board carrier according to the present invention.

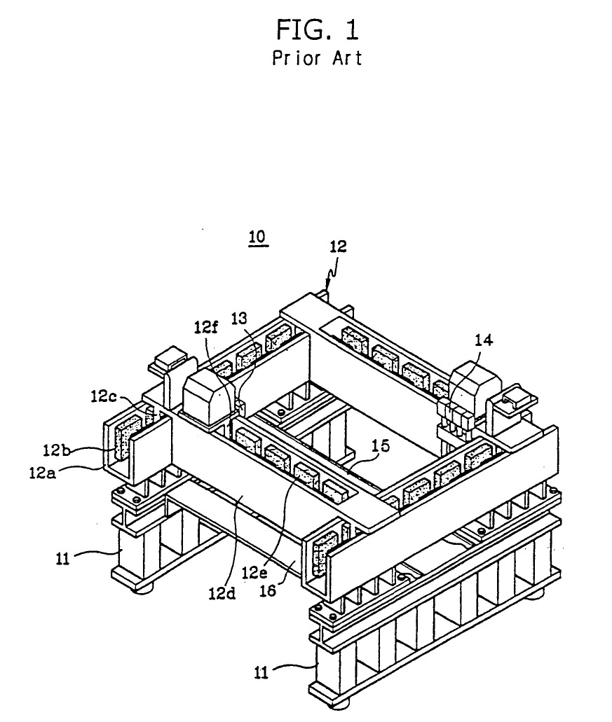

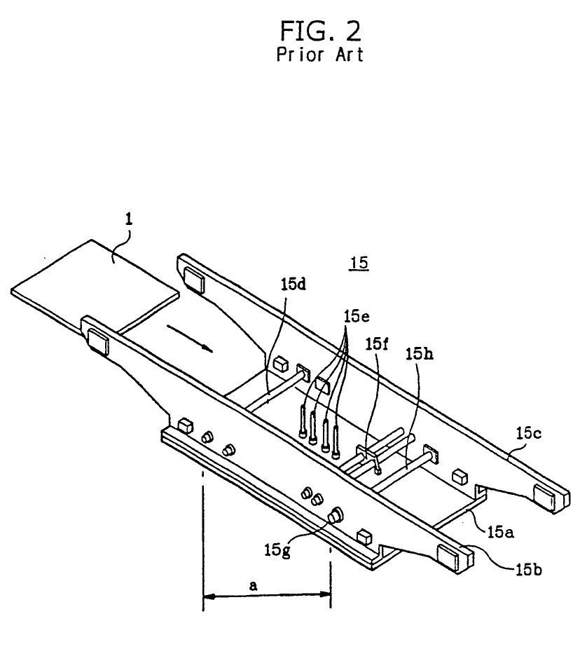

### DETAILED DESCRIPTION OF THE PREFERRED EMBODIMENT

A preferred embodiment of the present invention will now be described with reference to the accompanying drawings.

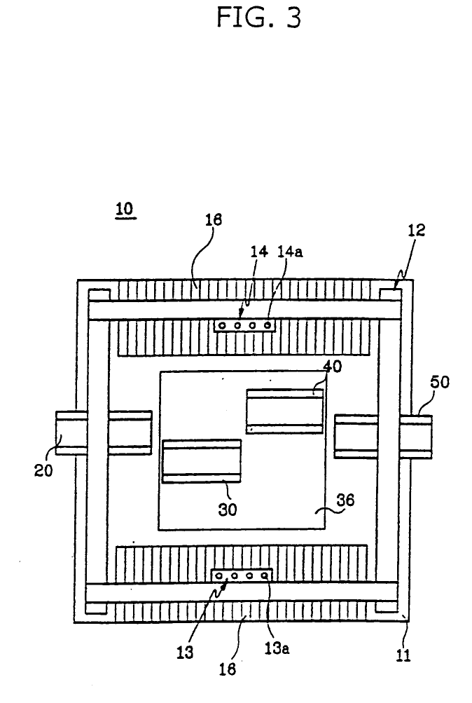

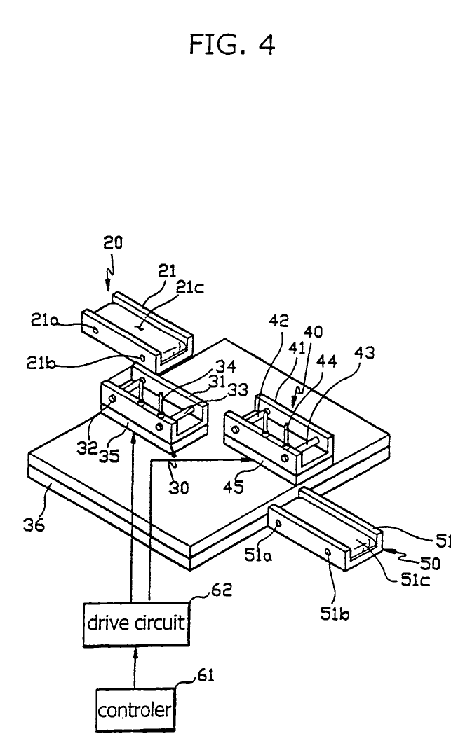

FIG. 3 is a plane view of a surface mounting device to which a printed circuit board carrier is adapted according to the present invention. FIG. 4 is a perspective view of the printed circuit board carrier as illustrated in FIG. 3. As illustrated therein, the printed circuit board carrier includes: a first transfer 20 fixedly assembled at a base frame of the surface mounting device and carrying a stored printed circuit board 1; a first conveyer 30 assembled over a plane stator frame 36 so that it is movable to an X-Y axis plane and carrying the printed circuit board 1 carried from the first transfer 20 to a parts mounting work position and discharging the printed circuit board onto which parts have been mounted; a second conveyer 40 installed over the plane stator frame 36 so that it is movable to the X-Y axis plane and selectively carrying the printed circuit board 1 carried from the first transfer 20 and the printed circuit board 1 carried from the first conveyer 30 to the parts mounting position and discharging the printed circuit board onto which parts have been mounted; a plane power transmission device having first and second plane movers 35 and 45 and the plane stator frame 36 in order to generate a moving force for moving the first conveyer 30 and the second conveyer 40 respectively in X and Y axis directions; and a second transfer 50 fixedly assembled at the base frame 11 of the surface mounting device 10 and selectively discharging the printed circuit board 1 discharged from the first conveyer 30 and the second conveyer 40.

The construction and operation of the surface mounting device of the present invention will now be described in more detail.

In the surface mounting device 10, as illustrated in FIG. 3, a X-Y gantry 12 is installed on the base frame 11, the first and second head units 13 and 14 each having nozzles 13a and 14a are installed at the X-Y gantry 12, and a feeder 16 at which a tape reel (not shown) is to be mounted is mounted at the bottom of the X-Y gantry 12. Between the base frame 11 on which the X-Y gantry 12 is installed and the X-Y gantry 12, the first transfer 20, second conveyer 30, second conveyer 40, and second transfer 50 are installed.

The first transfer 20 carrying the printed circuit board 1 to a parts mounting work position is fixedly installed at the base frame 11 of the surface mounting device 10. The first transfer 20 carries the printed circuit board in a stored state to the first conveyer 30 or to the second conveyer 40. The first conveyer 30 having received the printed circuit board 1 carries the carried printed circuit board 1 to the parts mounting work position, and then carries the printed circuit board 1 to the second transfer 50 when the mounting of parts is finished. The first conveyer 30 and the second conveyer 40 that has selectively received the printed circuit board 1 from the first transfer 20 carry the carried printed circuit board 1 to the parts mounting work position, and then carries the printed circuit board 1 to the second transfer 50 when the mounting of parts is finished. Here, parts to be mounted are simultaneously fed and mounted onto the printed circuit board 1 carried to the first conveyer 30 and the second conveyer 40 respectively.

The first conveyer 30 carrying the printed circuit board carried from the first transfer 20 to the parts mounting work position is assembled on the plane stator frame 36 of the plane power transmission device fixedly installed at the center of the base frame 11 and is installed to be movable in the X and Y directions. The printed circuit board 1 discharged from the first conveyer 30 that is assembled to be movable in the X and Y directions is carried to the second conveyer 40 or to the second transfer 50. Like the first conveyer 30, the second conveyer 40 is assembled on the plane stator frame 36 and is installed to be movable in the X and Y directions.

The second conveyer 40 installed on the plane stator frame 36 to be movable in the X-Y direction receives the printed circuit board 1 selectively carried from the first transfer 20 or the first conveyer 30, carries the same to the parts mounting work position, and then discharges the printed circuit board 1 when the mounting of parts is finished. The printed circuit board 1 discharged from the first conveyer 30 or the second conveyer 40 is carried to the second transfer 50. The second transfer 50 having received the printed circuit board 1 discharged from the first conveyer 30 or the second conveyer 40 is fixedly installed at the base frame 11 like the first transfer 20.

The second transfer 50 receives the printed circuit board 1 carried from the first conveyer 20 or the second conveyer 40 and discharges the printed circuit board 1 onto parts have been mounted. The first transfer 20, first conveyer 30, second conveyer 40, and second transfer 50 will now be described in more detail, which carry the printed circuit board 1 to the parts mounting work position and discharges the printed circuit board 1 onto which parts have been mounted.

The first transfer 20 includes a first transfer base frame 21, a plurality of first transfer rollers 21a and 21b and a first belt member 21c. The first transfer base frame 21 guides the printed circuit board 1 when carrying the printed circuit board 1, and has the plurality of first transfer rollers 21a and 21b installed on a sidewall thereof. The plurality of first transfer rollers 21a and 21b are rotated in a predetermined direction when the printed circuit board 1 is carried.

To carry the printed circuit board 1 to the first conveyer 20 by the rotation of the plurality of first transfer rollers 21a and 21b, the first belt member 21c is installed at the plurality of first transfer rollers 21a and 21b. In a state where the printed circuit board is placed on the first belt member 21c, the first belt member 21c is rotated by the rotation of the plurality of first transfer rollers 21a and 21b to carry the printed circuit board 1 to the first conveyer 30 or to the second conveyer 40.

The printed circuit board 1 carried by the first transfer 20 is carried to the parts mounting work position by the first conveyer 30. The first conveyer 30 carrying the printed circuit board 1 to the parts mounting position includes a first conveyer base frame 31, a first conveyer transfer roller 32, a first conveyer discharge roller 33 and a first conveyer lifting member 34.

The first conveyer base frame 31 of the first conveyer 30 guides the printed circuit board 1 when carrying the printed circuit board 1, and has a first plane mover 35 installed at the bottom thereof. The first plane mover 35 is installed on the plane stator frame 36 fixedly assembled at the base frame 11 of the surface mounting device 10. The first plane mover 35 has a plurality of armature coils (not shown) for interacting with a plurality of permanent magnets (not shown) assembled at the plane stator frame 36.

When an electric signal is fed to the first plane mover 35 of the plane power transmission device from the outside, a thrust force is generated between the plurality of permanent magnets assembled at the plane stator frame 36 and thusly the first plane mover 35 is moved in the X and Y axis directions. As the first plane mover 35 moves in the X and Y axis directions on the plane stator frame 36, the first conveyer 30 assembled at the first plane mover 35 is carried to the first transfer 20, second conveyer 40 and second transfer 50.

At one end of both sidewalls of the first conveyer base frame 31 movable in the X and Y axis directions on the plane stator frame 36, the first conveyer transfer roller 32 is installed. The first conveyer transfer roller 32 is rotated for carrying the printed circuit board 1 carried from the first transfer 20 to the parts mounting position. When the printed circuit board 1 is carried to the parts mounting position by the rotation of the first conveyer transfer roller 32, it is lifted at a predetermined height by the first conveyer lifting member 34.

When the mounting of parts is finished after the printed circuit board 1 is supported by the first conveyer lifting member 34, the printed circuit board 1 is contacted with the first conveyer discharge roller 33 as the first conveyer lifting member 34 is lowered to release the printed circuit board 1 from being lifted. The first conveyer discharge roller 33 is assembled at the other end of both sidewalls of the first conveyer base frame 31 and carries the printed circuit board 1 to the second conveyer 40 when the first conveyer lifting member 34 is lowered to release the printed circuit board from being lifted.

The printed circuit board 1 carried from the first conveyer 30 movable in the X and Y axis directions is directly carried to the second transfer 50 after it is carried to the second conveyer 40. The second conveyer 40 includes a second conveyer base frame 41, a second conveyer transfer roller 42, a second conveyer discharge roller 43, and a second conveyer lifting member 44, which receives the printed circuit board 1 carried from the first conveyer 30 or directly receives the printed circuit board 1 from the first transfer 20.

The second conveyer base frame 41 of the second conveyer 40 guides the printed circuit board 1 when carrying the printed circuit board 1 and has a second plane mover 45 installed at the bottom thereof. The second plane mover 45 is installed on the plane stator frame 36 fixedly assembled at the base frame 11 of the surface mounting device 10. The second plane mover 45 installed on the planes stator frame 36 has a plurality of armature coils (not shown) for interacting with a plurality of permanent magnets (not shown) assembled at the plane stator frame 36.

When an electric signal is fed to the second plane mover 45 of the plane power transmission device from the outside, a thrust force is generated between the plurality of permanent magnets assembled at the plane stator frame 36 and thusly the second plane mover 45 is moved in the X and Y axis directions. As the second plane mover 45 moves in the X and Y axis directions on the plane stator frame 36, the second conveyer 40 assembled at the second plane mover 45 is moved to the first transfer 20, first conveyer 30 and second transfer 50.

The second conveyer base frame 41 carried in the X and Y axis directions on the plane stator frame 36 guides the printed circuit board 1 when carrying the printed circuit board 1. At the same time, a second armature coil unit (not shown) is installed at the center of the bottom of the second conveyer base frame 41, and the second conveyer transfer roller 42 is installed at one end of both sidewalls of the second conveyer base frame 41. The second conveyer transfer roller 42 is rotated for carrying the printed circuit board 1 carried from the first conveyer 30 to the parts mounting work position. When the printed circuit board 1 is carried to the parts mounting work position by the rotation of the second conveyer transfer roller 42, it is lifted at a predetermined height by the second conveyer lifting member 44. Then, the lifting of the printed circuit board 1 is released when the mounting of parts is finished.

The printed circuit board 1 is carried to the second transfer 50 by the second conveyer discharge roller 43 assembled at the other end of both sidewalls of the second conveyer base frame 41. By directly carrying the printed circuit board 1 from the first transfer 20 to the second conveyer 40 and mounting parts on the printed circuit board 1 through the first conveyer 30 and the second conveyer 40, the parts mounting speed can be improved and the feed speed of the printed circuit board 1 also can be improved.

The second transfer 50 includes a second transfer base frame 51, a plurality of second transfer rollers 51a and 51b and a second belt member 51c, which has received the printed circuit board selectively carried from the first conveyer 30 and the second conveyer 40. The second transfer base frame 51 guides the printed circuit board 1 when the printed circuit board 1 is carried, and has the plurality of second transfer rollers 51a and 51b installed on a sidewall thereof at a predetermined interval. At the plurality of second transfer rollers 51a and 51b, the second belt member 51c is installed. The second belt member 51c is rotated by the plurality of second transfer rollers 51a and 51b to thus discharge the printed circuit board 1.

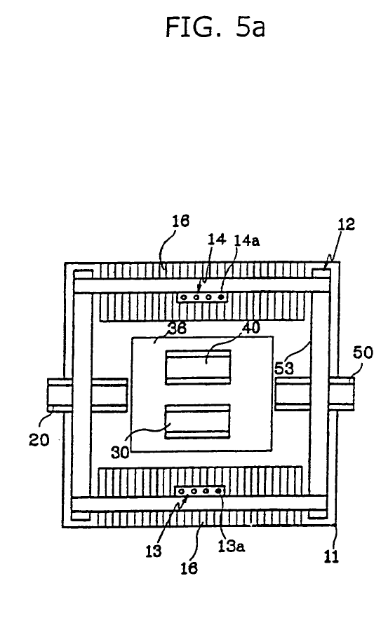

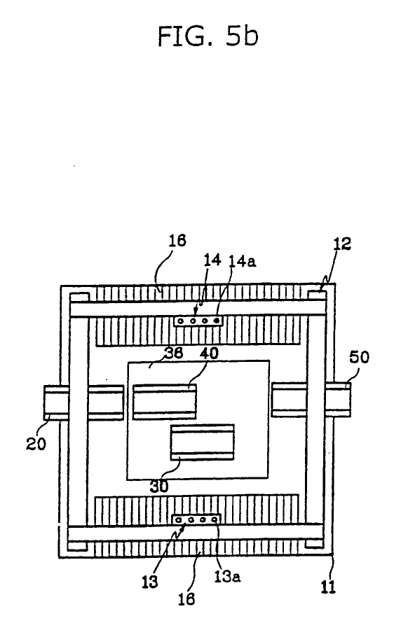

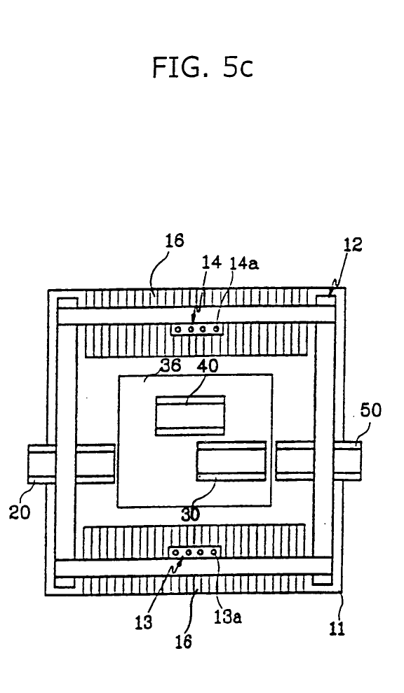

As described above, the first transfer 20, the first conveyer 30, the second conveyer 40 and the second transfer 50 are controlled by a controller 61 and a drive circuit 62 and, as illustrated in FIGS. 5a through 5c, are moved for carrying the printed circuit board 1.

FIG. 5a shows a state in which the first conveyer 30 and the second conveyer 40 are moved to a position for mounting parts on the carried printed circuit board 1.

A surface mounting method of the present invention includes the steps of: transferring a printed circuit board 1 from a first transfer 20 to one of a plurality of conveyers 30 and 40 movable in a predetermined direction; performing the mounting work of electronic parts from a feeder 16 on the printed circuit board 1; transferring the printed circuit board 1 onto which parts have been mounted to the other one of the plurality of conveyers 30 and 40; and transferring the printed circuit board 1 to a second transfer 50.

FIG. 5b shows a state in which the first conveyer 30 is moved to the parts mounting position and the second conveyer 40 is moved from the first transfer 20 to receive the printed circuit board 1 from the first transfer 20.

As illustrated in FIGS. 5a through 5c, another surface mounting method of the present invention includes the steps of: sequentially transferring a printed circuit board 1 from a first transfer 20 to a plurality of conveyers 30 and 40 movable in a predetermined direction; moving the printed circuit board 1 transferred earlier and placed on one of the plurality of conveyers 30 and 40 to a predetermined position to perform the mounting work of electronic parts and simultaneously moving the printed circuit board 1 transferred later and placed on the other one of the plurality of conveyers 30 and 40 to a predetermined position; transferring the printed circuit board onto which parts have been mounted to a second transfer 50 and simultaneously perform the mounting work of parts on the printed circuit board 1 moved to the predetermined position; and transferring the printed circuit board 1 onto which parts have been mounted to the second transfer 40.

FIG. 5c shows a state in which the first conveyer 30 is moved to the second conveyer 40 to directly carry the printed circuit board 1 to the second transfer 50 and simultaneously the second conveyer 50 is moved to the parts mounting work position.

The third surface mounting method of the present invention includes the steps of: sequentially transferring a printed circuit board 1 from a first transfer 20 to a plurality of conveyers 30 and 40 movable in a predetermined direction; moving the printed circuit board 1 placed on one of the plurality of conveyers 30 and 40 and the printed circuit board 1 placed on the other on of the plurality of conveyers 30 and 40 to a predetermined position for thereby performing the mounting work of electronic parts; transferring the printed circuit board 1 onto which electronic parts have been mounted earlier to the second transfer 40; and transferring the printed circuit board 1 onto which electronic parts have been mounted later to the second transfer 40.

As described above, the productivity of a parts mounting work can be improved by having a plurality of conveyers for carrying a printed circuit board, moving first and second conveyers freely in X and Y directions and moving first and second transfers in a Y direction.

As seen from above, there is an advantage that the surface mounting device and the method thereof according to the present invention improves the productivity of a parts mounting work by having a plurality of conveyers for carrying a printed circuit board, moving first and second conveyers freely in X and Y directions and moving first and second transfers in a Y direction.

What is claimed is:

1. A surface mounting device, comprising:
an X-Y gantry mounted on a base frame;
at least one head unit mounted on the X-Y gantry and configured to mount parts on a printed circuit board (PCB);
at least one feeder unit configured to supply parts to be mounted on a printed circuit board to the at least one head;
a plurality of transfers mounted on sides of the base frame; and
a plurality of movable conveyers mounted between the plurality of transfers, wherein the plurality of conveyers are movable in at least one of X and Y directions.

2. The surface mounting device of claim 1, wherein the plurality of transfers comprises a first transfer and a second transfer, and wherein the first and the second transfers each comprises:
a base frame configured to guide a printed circuit board;
a plurality of transfer rollers mounted at predetermined positions along the base frame; and
a belt member fitted to the plurality of transfer rollers.

3. The surface mounting device of claim 2, wherein the plurality of conveyers comprises a first conveyer and a second conveyer, and wherein the first and second conveyer each comprises:
a conveyer base frame;
a conveyer transfer roller configured to rotate and to transfer a printed circuit board from one of the transfers to a mounting area;
a conveyer lifting member configured to lift the printed circuit board to a predetermined height for mounting of parts and to lower the printed circuit board when the mounting of parts is finished; and
a conveyer discharging roller configured to discharge the printed circuit board to one of the transfers.

4. The surface mounting device of claim 1, further comprising a controller connected to a drive circuit, wherein the controller and the drive circuit are configured to control the positions of the plurality of transfers.

5. The surface mounting device of claim 1, further comprising a plane stator frame, wherein each of the plurality of movable conveyers are mounted over the plane stator frame, and wherein each of the plurality of movable conveyers comprises a plane mover that interacts with the plane stator frame to move its respective movable conveyer.

6. The surface mounting device of claim 5, wherein the plurality of movable conveyers are movable in both the X and Y directions across the plane stator frame.

7. The surface mounting device of claim 5, wherein the plane stator frame comprises a plurality of magnets, and wherein the plane mover of each of the plurality of movable conveyers comprises at least one armature coil.

8. The surface mounting device of claim 1, wherein the plurality of transfers comprise a first transfer and second transfer that are mounted substantially parallel to one another on opposite sides of the surface mounting device.

9. The surface mounting device of claim 1, wherein the plurality of conveyors are each configured to move in the X direction and in the Y direction.

10. The surface mounting device of claim 1, wherein each of the plurality of conveyors comprises a conveyor lifting member configured to lift a printed circuit board to a parts mounting position and configured to lower the printed circuit board when a parts mounting operation is complete.

11. The surface mounting device of claim 1, wherein each of the plurality of conveyors is configured to receive a PCB from one of the plurality of transfers, to convey the PCB to a first mounting position, and to convey the PCB from the first mounting position to another of the plurality of transfers or to another of the conveyors when a mounting operation is complete.

12. The surface mounting device of claim 1, wherein the plurality of conveyers comprises a first conveyer and a second conveyer, wherein the first conveyer is configured to receive a PCB from one of the plurality of transfers and to move the PCB to a plurality of different mounting positions, and wherein the first conveyer is configured to transfer the PCB to the second conveyer.

13. The surface mounting device of claim 12, wherein the second conveyer is configured to receive a PCB from the first conveyer and to move the PCB to a plurality of different mounting positions, and wherein the second conveyer is configured to transfer the PCB to one of the transfers.

14. A surface mounting device, comprising:
a base frame;
an X-Y gantry mounted on the base frame;
at least one mounting head on the X-Y gantry configured to mount parts on a printed circuit board (PCB);
a transfer mechanism mounted on the base frame and configured to supply PCBs into and out of the surface mounted device; and
at least one conveyor movably mounted on the base frame, wherein the conveyor is configured to move a PCB to a plurality of different mounting positions.

15. The surface mounting device of claim 14, wherein the at least one conveyor is configured to move in both the X direction and in the Y direction.

16. The surface mounting device of claim 14, wherein the at least one conveyer is configured to move in at least one of the X and Y directions to move a PCB to a plurality of different mounting positions.

17. The surface mounting device of claim 14, wherein the at least one conveyer is configured to receive a PCB directly from the transfer mechanism, to move the PCB to a plurality of different mounting positions, and to deliver the PCB back to the transfer mechanism after mounting operations are complete.

18. The surface mounting device of claim 14, wherein the at least one conveyor comprises a plurality of conveyers, and wherein each conveyor is configured to transfer a PCB to another of the plurality of conveyers.

19. The surface mounting device of claim 14, further comprising a plane stator mounted on the base frame, wherein the at least one conveyer is mounted on the plane stator.

20. The surface mounting device of claim 19, wherein the at least one conveyer comprises an armature coil configured to interact with the plane stator to cause the conveyer to move to different mounting positions.

21. The surface mounting device of claim 20, further comprising a controller coupled to the armature coil of the conveyer, wherein the controller is configured to cause the conveyer to move to different mounting positions by applying electrical signals to the conveyer.
